(19) United States
(12) Patent Application Publication
(10) Pub. No.: US 2026/0014962 A1
(43) Pub. Date: Jan. 15, 2026

(54) VEHICLE WASHER CONNECTOR

(71) Applicants: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(72) Inventors: Jong Min Park, Hwaseong-si (KR); Young Joo Cho, Hwaseong-si (KR); Jae Hyoung Kim, Asan-si (KR); Sin Won Kang, Asan-si (KR); Jong Hyun Jin, Asan-si (KR)

(73) Assignees: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(21) Appl. No.: 18/951,097

(22) Filed: Nov. 18, 2024

(30) Foreign Application Priority Data
Jul. 9, 2024 (KR) 10-2024-0090062

(51) Int. Cl. B60S 1/48; B60S 1/08

(52) U.S. Cl. CPC B60S 1/488; B60S 1/0866

(57) ABSTRACT

A vehicle washer connector includes a main body part connecting washer hoses to each other and a heating part mounted on the main body part. The heating part has a heating wire connected thereto and disposed on an inner side of the main body part and the heating part supplies power to heat the heating wire. The washer connector also includes a temperature sensor coupled to the main body part and configured to measure a temperature of washer fluid flowing through the main body part. The washer connector also includes a controller connected to the heating part and the temperature sensor. The controller selectively controls operation of the heating part by comparing the temperature of the washer fluid measured by the temperature sensor and a set temperature.

### CROSS-REFERENCE TO RELATED APPLICATION

This application claims, under 35 U.S.C. § 119(a), the benefit of priority to Korean Patent Application No. 10-2024-0090062, filed on Jul. 9, 2024, the entire contents of which are incorporated herein by reference.

### BACKGROUND

### (a) Technical Field

The present disclosure relates to a vehicle washer connector, and more particularly, to a vehicle washer connector configured to prevent deterioration in spray performance of washer fluid in a low temperature environment.

### (b) Background Art

Generally, a washer fluid spray device of a vehicle is a device configured to spray washer fluid onto the surface of a windshield and to spray washer fluid stored in a tank from a washer fluid spray nozzle through driving of a drive motor.

The washer fluid spray device may include a tank having washer fluid stored therein, a drive motor configured to pump washer fluid stored in the tank so as to supply spray pressure, a power supply means configured to supply power to the drive motor, a washer hose configured to deliver washer fluid pumped through the drive motor, and a spray nozzle configured to spray washer fluid delivered along the washer hose.

According to this configuration, when the drive motor is driven or operated, and washer fluid stored in the tank is supplied at a set spray pressure, washer fluid may be supplied at the set spray pressure and may flow along the washer hose. The washer fluid is thereby sprayed onto the surface of a windshield through the spray nozzle.

Therefore, washer fluid sprayed through the spray nozzle may remove foreign substances from the windshield, assisted by a pair of wipers configured to repeatedly move in the left-and-right direction on the surface of the windshield. In other words, washer fluid serves as a medium to clean the surface of the windshield.

Meanwhile, since the washer fluid spray device is installed on the outside of a vehicle, and particularly in winter, the spray nozzle may easily freeze when exposed to a relatively low outside temperature.

Therefore, in the related art, heat generated from an engine is used to prevent the washer fluid spray device from freezing at low temperatures. However, since it is not possible to use heat from an engine in battery-powered electric vehicles, there is a problem in that spray performance of washer fluid deteriorates at low temperatures.

### SUMMARY

The technical concepts of the present disclosure have been made in an effort to solve the above-described problems associated with the prior art. It is an object of the present disclosure to provide a vehicle washer connector including a main body part connecting washer hoses to each other. The vehicle washer connector measures, in real time, the temperature of washer fluid flowing through the main body part having a temperature sensor mounted thereon. A heating part including a heating element is fixedly coupled to the main body part and selectively supplies power to operate the heating part by comparing the temperature of washer fluid with a set temperature. It is thereby possible not only to maintain the washer fluid at a constant temperature, but also to prevent deterioration in spray performance of washer fluid in a low temperature environment.

In one aspect, the present disclosure provides a vehicle washer connector including a main body part connecting washer hoses to each other and a heating part mounted on the main body part. The heating part has a heating wire connected thereto and disposed on an inner side of the main body part and supplies power to heat the heating wire. The washer connector also includes a temperature sensor coupled to the main body part and configured to measure temperature of washer fluid flowing through the main body part. The washer connector further includes a controller connected to the heating part and the temperature sensor. The controller selectively controls operation of the heating part through comparison between the temperature of the washer fluid measured by the temperature sensor and a set temperature.

In an embodiment, the heating part may have an inclination relative to the main body part and may be integrally mounted on the main body part.

In another embodiment, the temperature sensor may be mounted in the main body part in a detachable manner.

In still another embodiment, the temperature sensor may be inserted into and mounted in a mounting area formed in the main body part and may be inserted into the mounting area in a state of being spaced apart from the heating wire disposed on the inner side of the main body part.

In yet another embodiment, the controller, upon determining that the temperature of the washer fluid measured by the temperature sensor is below the set temperature, may perform a control operation to supply the power to the heating part.

In still yet another embodiment, the controller, upon determining that the temperature of the washer fluid measured by the temperature sensor is equal to or higher than the set temperature, may perform a control operation to cut off the power supplied to the heating part.

In a further embodiment, the vehicle washer connector may further include a pressure sensor mounted in the main body part and configured to measure pressure of the washer fluid flowing through the main body part.

In another further embodiment, when the temperature sensor is separated from the mounting area formed in the main body part, the pressure sensor is coupled to the mounting area.

In still another further embodiment, the pressure sensor may be mounted in the main body part in a state of being spaced apart from the temperature sensor.

Other aspects and embodiments of the disclosure are discussed herein.

It should be understood that the terms “vehicle”, “vehicular”, and other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed herein.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a diagram schematically showing a vehicle washer connector according to an embodiment of the present disclosure;

FIG. 2 is a diagram showing a state in which a temperature sensor is separated from a vehicle washer connector according to an embodiment of the present disclosure;

FIG. 3 is a diagram showing control of a heating part for a vehicle washer connector according to an embodiment of the present disclosure;

FIG. 4 is a diagram showing a state in which a temperature sensor is coupled to a vehicle washer connector according to an embodiment of the present disclosure; and

FIG. 5 is a diagram showing a state in which a pressure sensor is coupled to a vehicle washer connector according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below.

Advantages and features of the washer connector of the present disclosure and a method of achieving the same should become more apparent with reference to the embodiments described below in detail and the accompanying drawings. When a component, device, element, or the like of the present disclosure is described as having a purpose or performing an operation, function, or the like, the component, device, element, or the like should be considered herein as being “configured to” meet that purpose or to perform that operation or function. Each component, device, element, or the like, and particularly the controller, may separately embody or be included with a processor and a memory, such as a non-transitory computer readable media, as part of the apparatus.

However, the present disclosure is not limited by the embodiments disclosed below and the embodiments may be implemented in various forms. The disclosed embodiments are provided to ensure that the present disclosure is complete, and to more fully illuminate the scope of the disclosure to those of ordinary skill in the art to which the present disclosure pertains. The present disclosure is only defined by the scope of the claims.

In describing the embodiments disclosed herein, where it has been is determined that a detailed description of publicly known techniques to which the disclosure pertains may have obscured the gist of the present disclosure, the detailed description thereof has been omitted.

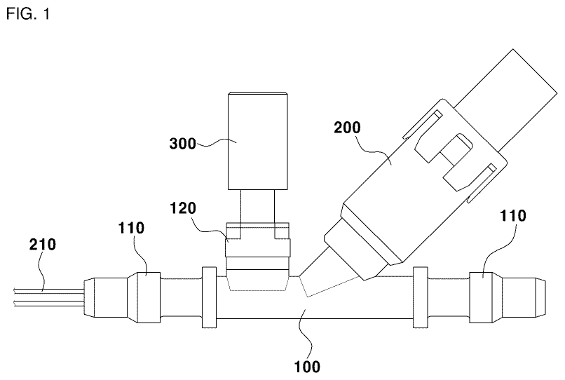

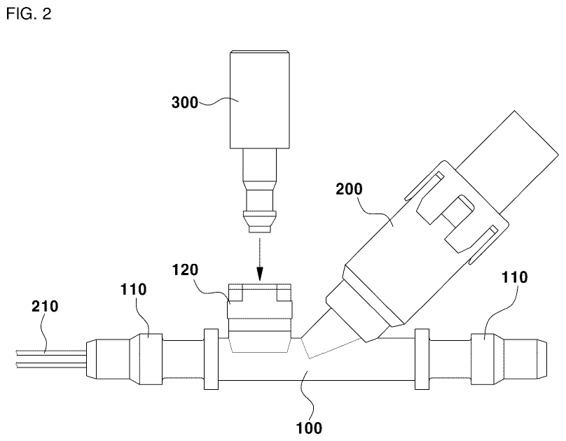

FIG. 1 is a diagram schematically showing a vehicle washer connector according to an embodiment of the present disclosure. FIG. 2 is a diagram showing a state in which a temperature sensor is separated from a vehicle washer connector according to an embodiment of the present disclosure.

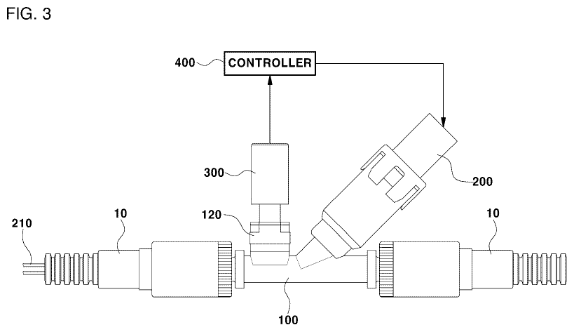

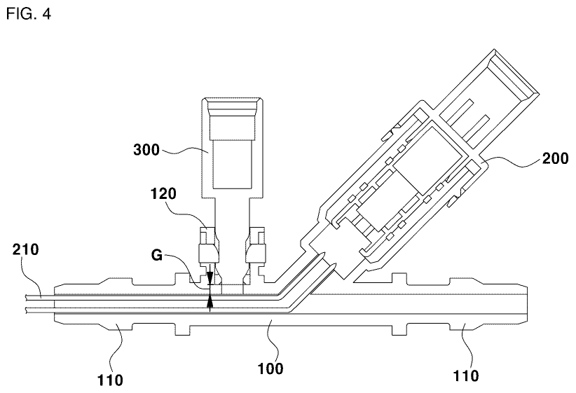

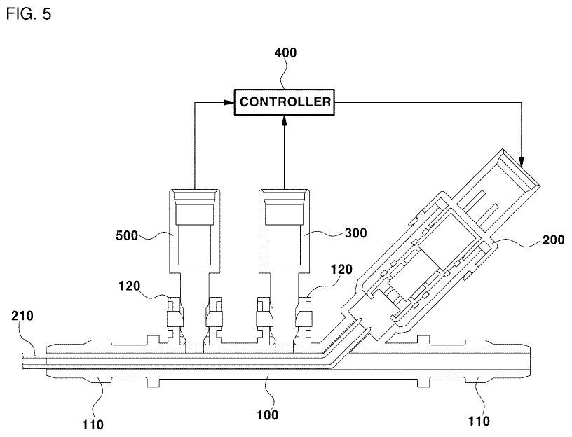

Further, FIG. 3 is a diagram showing control of a heating part for a vehicle washer connector according to an embodiment of the present disclosure. FIG. 4 is a diagram showing a state in which a temperature sensor is coupled to a vehicle washer connector according to an embodiment of the present disclosure. FIG. 5 is a diagram showing a state in which a pressure sensor is coupled to a vehicle washer connector according to an embodiment of the present disclosure.

As shown in FIG. 1, a vehicle washer connector according to an embodiment includes a main body part 100, a heating part 200, and a temperature sensor 300.

Although not shown in the drawings, the main body part 100 is formed to connect typical washer hoses 10 to each other. Washer fluid pumped through a drive motor (not shown) is delivered through the washer hoses 10 (refer to FIG. 3).

The main body part 100 is formed to have a predetermined length. Specifically, the main body part 100 may include protrusions 110 respectively having enlarged diameters respectively formed at one end of the main body part 100 and the other end thereof. In this manner, the main body part 100 is inserted into the washer hoses 10 spaced apart and facing each other.

In addition, the heating part 200 is mounted on the outside of the main body part 100 and has a predetermined length. Specifically, the heating part 200 allows a heating wire 210 extending to the washer hose 10 to be disposed on the inner peripheral surface of the main body part 100.

The heating part 200 is configured to supply power to heat the heating wire 210. As described above, the heating part 200 has the heating wire 210 disposed on the inner peripheral surface of the main body part 100 and formed to extend to the washer hose 10 (refer to FIG. 4). In this manner, when the heating wire 210 is heated by power supplied by the heating part, the temperature of washer fluid discharged through the main body part 100 may be increased by the heating wire 210.

The heating part 200 is mounted on the outside of the main body part 100 with a predetermined inclination, i.e., incline or incline angle, relative to the main body part 100. An area occupied by the heating part 200 protruding from the main body part 100 is thereby maximally reduced and a layout designed to achieve effective mounting of the vehicle washer connector on a vehicle is reliably secured.

The temperature sensor 300 is coupled to the main body part 100 and measures the temperature of washer fluid flowing through the main body part 100.

In an embodiment, the temperature sensor 300 may be formed of a non-contact temperature sensor implementing an infrared or laser scanning method. However, this configuration only corresponds to one embodiment and the present disclosure is not limited thereto. The temperature sensor 300 may be formed of any one of sensors respectively using various methods of measuring the temperature of washer fluid delivered along the main body part 100.

Further, as shown in FIG. 2, the temperature sensor 300 may be inserted into and coupled to a mounting area 120 of the main body part 100.

Accordingly, the temperature sensor 300 is detachable from the main body part 100. Through this structural configuration, when the temperature sensor 300 is broken, the temperature sensor 300 may be easily separated from the main body part 100 and may be replaced with a new one, thereby allowing for performing appropriate maintenance thereon.

In addition, the temperature sensor 300 is inserted into and mounted in the mounting area 120. As shown in FIG. 4, it is desirable that the insertion position of the temperature sensor 300 be spaced apart from the heating wire 210 disposed on the inner peripheral surface of the main body part 100 by a predetermined distance G.

The reason for this is that, when the temperature sensor 300 is inserted into the mounting area 120 so as to contact the heating wire 210, the temperature of washer fluid flowing through the main body part 100 may not be accurately measured due to the temperature of the heated heating wire 210. Therefore, the temperature sensor 300 is inserted into the mounting area 120 in a state of being spaced apart from the heating wire 210 so as to have the predetermined gap G therebetween. Accurately measuring the temperature of washer fluid is thereby achieved.

Meanwhile, the vehicle washer connector according to the embodiment includes a controller 400, as shown in FIG. 3.

The controller 400 is connected to the heating part 200 and the temperature sensor 300 and compares the temperature of washer fluid measured by the temperature sensor 300 with a set temperature. This permits selectively controlling the operation of the heating part 200.

In other words, upon determining that the temperature of washer fluid measured by the temperature sensor 300 is below the set temperature, the controller 400 performs a control operation to supply power to the heating part 200 so as to heat the heating element 210.

In other words, in winter or in extremely cold areas, freezing of washer fluid may occur due to low outside temperatures. In this case, freezing of washer fluid may be prevented through heat generated from an engine. Meanwhile, since heat from an engine of the vehicle is not usable in battery-powered electric vehicles, the heating wire 210 is controlled to be selectively heated through temperature measurement of washer fluid using the temperature sensor 300. This makes it possible to prevent freezing of washer fluid.

Here, the set temperature may be set to a critical temperature at which freezing of washer fluid may occur. Further, the set temperature may be set differently depending on the outside temperature and may be stored in the controller 400.

Additionally, upon determining that the temperature of washer fluid measured by the temperature sensor 300 is higher than the set temperature, the controller 400 may perform a control operation to cut off power supply of the heating part 200 so that the heating element 210 returns to an initial state, i.e., an unheated state.

More specifically, as described above, in a state in which power is supplied from the heating part 200 depending on the temperature of washer fluid, upon determining that the temperature of washer fluid has risen above the set temperature by the heated heating element 210, the controller 400 adjusts voltage supplied to the heating part 200 to a low level or performs a control operation to cut off power supply. This aids in maximally reducing power consumption and maximally improving thermal efficiency.

As described above, the controller 400 performs a control operation to selectively supply or cut off power for operation of the heating part 200 or to adjust voltage supplied to the heating part 200. The controller 400 may do so through comparison between the temperature of washer fluid measured by the temperature sensor 300 and the set temperature, i.e., by comparing the washer fluid temperature to the set temperature. In this manner, the controller 400 may reliably maintain a constant temperature of washer fluid to be discharged. As a result, it is possible to prevent deterioration in spray performance of washer fluid.

Meanwhile, the vehicle washer connector according to an embodiment may further include a pressure sensor 500 shown in FIG. 5.

The pressure sensor 500 may be mounted in the main body part 100 using a quick connector in the same manner as that of the temperature sensor 300 described above. The pressure sensor 500 may also be provided to measure the pressure of washer fluid flowing through the main body part 100.

The pressure sensor 500 may be coupled to the main body part 100 so as to be spaced apart from the temperature sensor 300. Further, the pressure sensor 500 may be electrically connected to the controller 400 in the same manner as those of the heating part 200 and the temperature sensor 300 so as to perform different control operations depending on temperature and pressure conditions.

For example, upon determining that the temperature and pressure of washer fluid are under conditions of high temperature and low pressure, the controller 400 may predict failure of a drive motor used to deliver pumped washer fluid. In addition, upon determining that the temperature and pressure of washer fluid are under conditions of high temperature and high pressure, the controller 400 may maximally reduce power consumption thereof by lowering the output of the drive motor.

As another example, upon determining that the temperature and pressure of washer fluid are under conditions of low temperature and low pressure, the controller 400 determines that the output of the drive motor will increase due to an increase in kinematic viscosity of washer fluid in a low temperature state. In this case, the controller 400 may perform a control operation to supply power to the heating part 300 (refer to FIG. 5), thereby lowering the kinematic viscosity of washer fluid. Additionally, upon determining that the temperature and pressure of washer fluid are under conditions of low temperature and high pressure, the controller 400 may perform a control operation to lower the output of the drive motor, thereby maximally reducing power consumption.

The present disclosure provides a vehicle washer connector including a main body part connecting washer hoses to each other. The vehicle washer connector measures, in real time, the temperature of washer fluid flowing through the main body part. The main body part has a temperature sensor mounted thereon in a state in which a heating part including a heating element is fixedly coupled to the main body part. The washer connector selectively supplies power to operate the heating part through comparison between the temperature of washer fluid and a set temperature, thereby having an effect of maintaining the washer fluid at a constant temperature.

Accordingly, in the present disclosure, it is possible to prevent deterioration in spray performance of washer fluid in a low temperature environment. This has an effect of reliably removing foreign substances on the windshield.

In addition, in the present disclosure, the temperature of washer fluid is measured in real time through the temperature sensor. Also, a control operation is performed to cut off power supplied to the heating part when it is determined that the temperature of washer fluid has reached the set temperature. This has an effect of maximally reducing power consumption and maximally improving thermal efficiency.

Furthermore, in addition to the temperature sensor, a pressure sensor is additionally mounted in the main body part to selectively operate the drive motor and the heating part depending on the temperature and pressure conditions of washer fluid. This has an effect of maximally reducing power consumption caused by failure inspection of the drive motor and adjustment of the output of the drive motor.

As should be apparent from the above description, the present disclosure provides a vehicle washer connector including a main body part connecting washer hoses to each other. The vehicle washer connector measures, in real time, the temperature of washer fluid flowing through the main body part, which has a temperature sensor mounted thereon in a state in which a heating part including a heating element is fixedly coupled to the main body part. Additionally, the vehicle washer connector selectively supplies power to operate the heating part by comparing the temperature of washer fluid with a set temperature. This has an effect of maintaining the washer fluid at a constant temperature.

Accordingly, it is possible to prevent deterioration in spray performance of washer fluid in a low temperature environment. This has an effect of reliably removing foreign substances on the windshield.

Furthermore, the temperature sensor measures, in real time, the temperature of washer fluid, and a controller, upon determining that the temperature of washer fluid has reached the set temperature, performs a control operation to cut off power supplied to the heating part. This has an effect of maximally reducing power consumption and maximally improving thermal efficiency.

Further, in addition to the temperature sensor, the main body part has a pressure sensor mounted therein and configured to selectively operate the drive motor and the heating part depending on the temperature and pressure conditions of washer fluid. This has an effect of maximally reducing power consumption caused by failure inspection of the drive motor and adjustment of the output of the drive motor.

The technical concepts of the present disclosure has been described in detail with reference to various embodiments shown in the drawings, but the embodiments are merely illustrative. It should be appreciated by those having ordinary skill in the art that various modifications may be made from the embodiments, and all or a part of the embodiments may be selectively combined with each other. Therefore, the true technical scope of protection of the present disclosure should be defined by the technical spirit of the appended claims.

What is claimed is:

1. A vehicle washer connector comprising:
a main body part connecting washer hoses to each other;
a heating part mounted on the main body part, wherein the heating part has a heating wire connected thereto and disposed on an inner side of the main body part and is configured to supply power to heat the heating wire;
a temperature sensor coupled to the main body part and configured to measure a temperature of washer fluid flowing through the main body part; and
a controller connected to the heating part and the temperature sensor, wherein the controller selectively controls operation of the heating part by comparing the temperature of the washer fluid measured by the temperature sensor and a set temperature.

2. The vehicle washer connector of claim 1, wherein the heating part is inclined relative to the main body part.

3. The vehicle washer connector of claim 2, wherein the heating part is integrally mounted on the main body part.

4. The vehicle washer connector of claim 1, wherein the temperature sensor is mounted in the main body part in is detachable from the main body part.

5. The vehicle washer connector of claim 1, wherein the temperature sensor is mounted in a mounting area formed in the main body part and is disposed in the mounting area spaced apart from the heating wire that is disposed on the inner side of the main body part.

6. The vehicle washer connector of claim 1, wherein the controller, upon determining that the temperature of the washer fluid measured by the temperature sensor is below the set temperature, performs a control operation to supply the power to the heating part.

7. The vehicle washer connector of claim 1, wherein the controller, upon determining that the temperature of the washer fluid measured by the temperature sensor is equal to or higher than the set temperature, performs a control operation to cut off the power supplied to the heating part.

8. The vehicle washer connector of claim 1, further comprising a pressure sensor mounted in the main body part and configured to measure pressure of the washer fluid flowing through the main body part.

9. The vehicle washer connector of claim 8, wherein the pressure sensor is disposed in the main body part spaced apart from the temperature sensor.
